(19) United States
(12) Patent Application Publication
(10) Pub. No.: US 2024/0413532 A1
(43) Pub. Date: Dec. 12, 2024

(54) NESTED CONCENTRIC COAXIAL FEED ASSEMBLY FOR GROUND ANTENNAS SUPPORTING MULTIPLE FREQUENCY BANDS

(71) Applicant: Custom Microwave Inc., Longmont, CO (US)

(72) Inventors: Maxim Vladimirovich Ignatenko, Superior, CO (US); Philip Elwood Venezia, Longmont, CO (US); Sudhakar Krothapali Rao, Rancho Palos Verdes, CA (US); Clency Lee-Yow, Niwot, CO (US); Richard Malcolm Dart, Arvada, CO (US)

(21) Appl. No.: 18/628,576

(22) Filed: Apr. 5, 2024

(51) Int. Cl. H01Q 5/47; H01Q 5/55; H01Q 15/24; H01Q 19/19

(52) U.S. Cl. CPC H01Q 5/47; H01Q 5/55; H01Q 15/244; H01Q 19/191

(57) ABSTRACT

A multi-band ground antenna with a nested concentric coaxial feed assembly is disclosed for supporting multiple frequency bands. The nested concentric coaxial feed assembly is attached to an antenna reflector through an attachment unit. The nested concentric coaxial feed assembly is located at a reflector focal point. The nested concentric coaxial feed assembly comprises an elongated housing, a feed cone, and a sub-reflector. The nested concentric coaxial feed assembly operates seamlessly across a wider bandwidth, without any gaps or performance drops. The multi-band ground antenna with multiple bands is being introduced for ground communications. The multi-band ground antenna comprises a nested concentric coaxial feed assembly, which supports a wide range of frequencies varies between 2 GHz and 36 GHz. The multi-band ground antenna is designed to be used in satellites and aircraft.

The present disclosure relates generally to cutting-edge antenna systems for satellite and aircraft systems, and more particularly to a multi-band ground antenna utilizing nested concentric coaxial feed assembly that operates seamlessly across a wider bandwidth simultaneously or individually at several frequency bands supporting all satellite and deep-space communications services.

### BACKGROUND

Deep Space Network (DSN) plays a vital role in space exploration by enabling communication with spacecraft across vast distances. In DSN, powerful antennas rely on reflectors and specialized mirrors (FSS sub-reflectors) to separate and handle different radio frequencies used for communication. However, this technology faces limitations that hinder the network's full potential.

At present, existing DSN antennas can typically handle 3 frequency bands (L, S, and Ka). The need for accessing additional bands like C, X, Ku, K, and upper Ka remains unmet. These additional bands are crucial for supporting a wider range of satellites, aircraft, and deep-space missions with varying communication requirements. Further, the intricate mirrors of the FSS sub-reflectors play a key role in separating frequencies within the antenna. However, the FSS can't handle many closely spaced frequencies, leading to limited mission capabilities.

Antennas are made out of combinations of several simple antennas that function as a single antenna. Aperture antennas made of an outer, surrounding reflective surface whose shape concentrates waves striking it onto a small inner simple antenna, the inner antenna can be either resonant or non-resonant, as shown in FIG. 1A. Many conventional antennas, particularly large ones like those used in the Deep Space Network (DSN), utilize support struts for structural integrity. FIG. 1A depicts a conventional antenna 18 with a main reflector 20, and struts 22 that are essential for holding a sub-reflector 24 to the main reflector 20 and ensuring proper antenna alignment. However, the struts 22 introduces an undesirable side effect. The struts 22 are typically metallic structures positioned across the main reflector 16 of the antenna 18. Radio waves, which are essentially electromagnetic waves, travel through the aperture to reach the sub-reflector 24 and two feeds 25 and 26. The metallic struts act as obstacles, blocking or attenuating these radio waves as they pass through.

Further, the degree of signal blockage depends on various factors like strut thickness, material properties, and their positioning within the aperture. Even minor signal attenuation can degrade antenna to blockage and steering effects of the struts degrading the antenna performance in terms of gain, sidelobes and cross-polar levels.

Due to above mentioned limitations, traditional antennas often support only a limited number of frequency bands, such as S and K bands, hindering communication with spacecraft utilizing different bands for specific purposes. This can restrict data transmission and reception, impacting scientific observations and mission control capabilities. Existing antennas might not have the sensitivity or gain required to communicate effectively with spacecraft at extreme distances, limiting the reach of deep space missions and hindering data acquisition from distant objects. If several spacecraft or missions within range utilize the same limited frequencies, signal interference can occur, leading to data corruption and communication disruptions.

Further, many current antennas have narrow bandwidths, restricting the amount of data that can be transmitted or received within a specific time frame. This can be detrimental for missions requiring high data throughput, such as real-time video or large scientific datasets or RF sensing. As radio waves travel through vast distances in space, they weaken. Existing antennas might not possess sufficient gain to amplify these weakened signals effectively, resulting in slower data transfer rates and potential data loss. Due to communication limitations, crucial scientific data from spacecraft instruments might be lost or corrupted, hindering scientific understanding and discovery. Real-time data streams might be disrupted or delayed, impacting critical decision-making processes and mission control operations. If communication bandwidth is insufficient, the amount and resolution of scientific data collected from instruments could be restricted, compromising the scientific value of missions.

There are different ways to overcome the limitation mentioned above. One method is to use multiple separate feeds with dichroic plates or physical switching between the feeds to enable multiband operation. However, this approach requires long cables, which results in high loss, or the bands are not available simultaneously. Another method is to use PCB-based antennas or quad-rigged horns for multiband operation. However, the power handling capability of these methods is limited at Ka-band due to the small size of the features.

Therefore, there is a need for a multiple frequency band operation of ground antennas and in particular coaxial cavity ring feed structure that provides expanded frequency range. There is also a need for a multiple coaxial cavity ring feed structure and sub-reflector that can avoid signal blockage, thereby improving overall antenna performance and enhance gain.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a multi-band ground antenna utilizing nested concentric coaxial feed assembly that provides expanded frequency range. These multi-band ground antennas are crucial for reliable and efficient communication in demanding environments.

In one embodiment, a multi-band ground antenna with a nested concentric coaxial feed assembly is disclosed for supporting multiple frequency bands. The nested concentric coaxial feed assembly is attached to an antenna reflector through an attachment unit. The nested concentric coaxial feed assembly is located at a reflector focal point. The nested concentric coaxial feed assembly comprises an elongated housing, a feed cone, and a sub-reflector. The nested concentric coaxial feed assembly operates seamlessly across a wider bandwidth, without any gaps or performance drops.

In one embodiment, the elongated housing is configured to enclose one or more antenna components. One end of the elongated housing is attached to the antenna reflector at the reflector focal point. The feed cone is attached at one end of the elongated housing. The feed cone comprises a first waveguide surrounded by one or more coaxial cylinders. These coaxial cylinders are configured to form one or more coaxial waveguides within the feed cone. Each coaxial waveguide is formed by an air gap between two adjacent coaxial cylinders. The coaxial waveguides comprise an intermediate waveguide and an outermost waveguide.

In specific, the first waveguide is a circular horn open-ended waveguide or a cylindrical core waveguide. The coaxial waveguides are coaxial horn open-ended waveguide.

In another embodiment, the nested concentric coaxial feed assembly includes a cylindrical core waveguide, encircled by two hollow coaxial cylinders, which respectively forms two coaxial waveguides. The coaxial waveguide could be an outermost waveguide and is bounded between hollow cylinder and hollow cylinder. The coaxial waveguide could be an intermediate waveguide that is bounded between hollow cylinder and cylindrical core waveguide.

In one embodiment, the nested concentric coaxial feed assembly further comprising at least one impedance matching structure encircling at least one coaxial cylinder. The impedance matching structure is configured to adjust the impedance of the nested concentric coaxial feed assembly. The impedance matching structure have a shape includes at least one of a ramp, steps and a descending curve. The nested concentric coaxial feed assembly further comprising one or more coaxial connectors disposed on at least one coaxial cylinder. The coaxial connectors are configured to connect to the antenna components. The coaxial waveguide is incorporated with a beam forming network (BFN) for limiting power usage.

In one embodiment, the antenna components include at least one of switches, filters, amplifiers, coaxial cables and other similar components. The sub-reflector supports are extending from the feed cone. The sub-reflector features an inner reflecting surface specifically designed and shaped to minimize radio frequency (RF) blockage effects and enhance the gain of the multi-band ground antenna. Further, the multi-band ground antenna is connected to a plurality of radio frequency (RF) tracking networks. The RF tracking networks operate at one or more frequency bands for providing accurate positioning of the multi-band ground antenna to receive radio frequency signals.

In one embodiment, the nested concentric coaxial feed assembly further comprising one or more waveguide ports. The waveguide ports are configured for providing a sum signal and/or a difference signals at one or more high frequency bands (for example, K, Ka & upper Ka bands). Coaxial ports are used at lower frequency bands (for example, L, S, C, X, & Ku bands) where one or more coaxial cavities are nested around the central waveguide radiator. The multi-band ground antenna is configured to operate across a wide range of frequencies varying between 2 GHz and 36 GHz. The multi-band ground antenna is configured to operate in multiple frequency bands including L, S, C, X, Ku, K, Ka, and upper Ka bands.

An embodiment of the first aspect wherein a method for operating the multi-band ground antenna to support multiple frequency bands. The method comprises selecting a desired frequency band based on a required communication channel. The method further comprises directing signals through a corresponding waveguide based on a frequency coverage. The method comprises utilizing one or more integrated components within the feed cone for signal processing and transmission or reception. The method thereafter comprises maintaining continuous bandwidth, dual polarization, and tracking capability across all supported frequency bands.

In one embodiment, the inner radiating surface of the sub-rector is shaped such that RF signals from the feed and sub-rector are not blocked resulting in increased antenna gain

In all above embodiments, the antennas do not require any frequency selective surfaces to separate various frequency bands.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1A illustrates a perspective view of a conventional ground antenna with main-reflector, sub-reflector, struts, feeds, coaxial cables, in accordance with prior art embodiments of the invention.

FIG. 1B illustrates a perspective view of a multi-band ground antenna with a nested concentric coaxial feed assembly for supporting multiple frequency bands and a sub-reflector, in accordance with embodiments of the invention.

FIG. 1C illustrates a perspective view of the nested concentric coaxial feed assembly and the sub-reflector, in accordance with embodiments of the invention.

FIG. 1D illustrates a perspective view of a feed cone of the nested concentric coaxial feed assembly, in accordance with embodiments of the invention.

FIG. 1E illustrates a cross-sectional view of the feed cone, in accordance with embodiments of the invention.

FIG. 1F illustrates a cross-sectional front view of the feed cone, in accordance with embodiments of the invention.

FIG. 1G illustrates a schematic view of the feed cone and the central waveguide and the coaxial cavities, in accordance with embodiments of the invention.

FIG. 2A illustrates a block diagram of a ground station system, in accordance with embodiments of the invention.

FIG. 2B illustrates a flowchart a method for operating the multi-band ground antenna to support multiple frequency bands, in accordance with embodiments of the invention.

FIGS. 3A-3B illustrate a block diagram of the feed cone, in accordance with embodiments of the invention.

FIG. 4A illustrates a graphical plot depicting voltage standing wave ratio (VSWR) of the first waveguide, in accordance with embodiments of the invention.

FIG. 4B illustrates a graphical plot depicting VSWR of one of the coaxial cavities, in accordance with embodiments of the invention.

FIG. 4C illustrates a graphical plot depicting VSWR of an outermost coaxial cavities, in accordance with embodiments of the invention.

FIG. 5A illustrates radiation patterns of the nested concentric coaxial feed assembly at 36 GHz, in accordance with embodiments of the invention.

FIG. 5B illustrates radiation patterns of the nested concentric coaxial feed assembly at 26 GHz, in accordance with embodiments of the invention.

FIG. 5C illustrates radiation patterns of the nested concentric coaxial feed assembly at 19 GHz, in accordance with embodiments of the invention.

FIG. 5D illustrates radiation patterns of the nested concentric coaxial feed assembly at 9 GHz, in accordance with embodiments of the invention.

FIG. 5E illustrates radiation patterns of the nested concentric coaxial feed assembly at 6 GHz, in accordance with embodiments of the invention.

FIG. 5F illustrates radiation patterns of the nested concentric coaxial feed assembly at 4 GHz, in accordance with embodiments of the invention.

FIG. 5G illustrates radiation patterns of the nested concentric coaxial feed assembly at 2 GHz, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

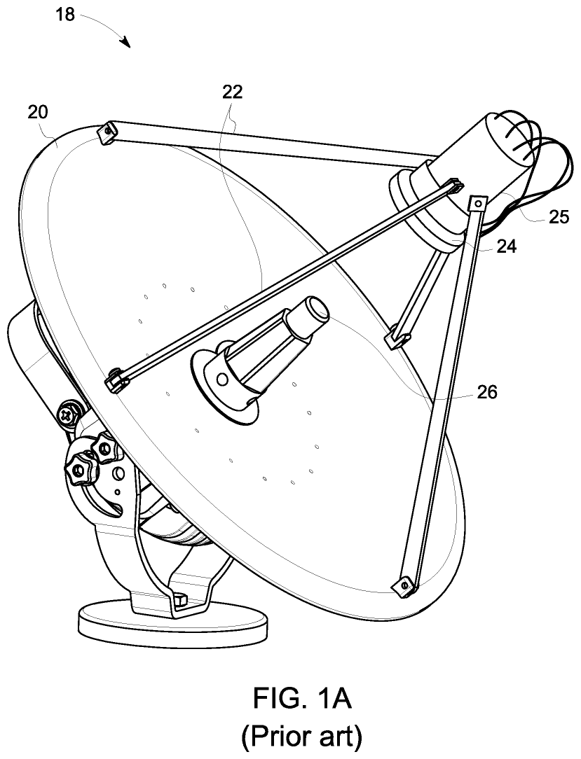

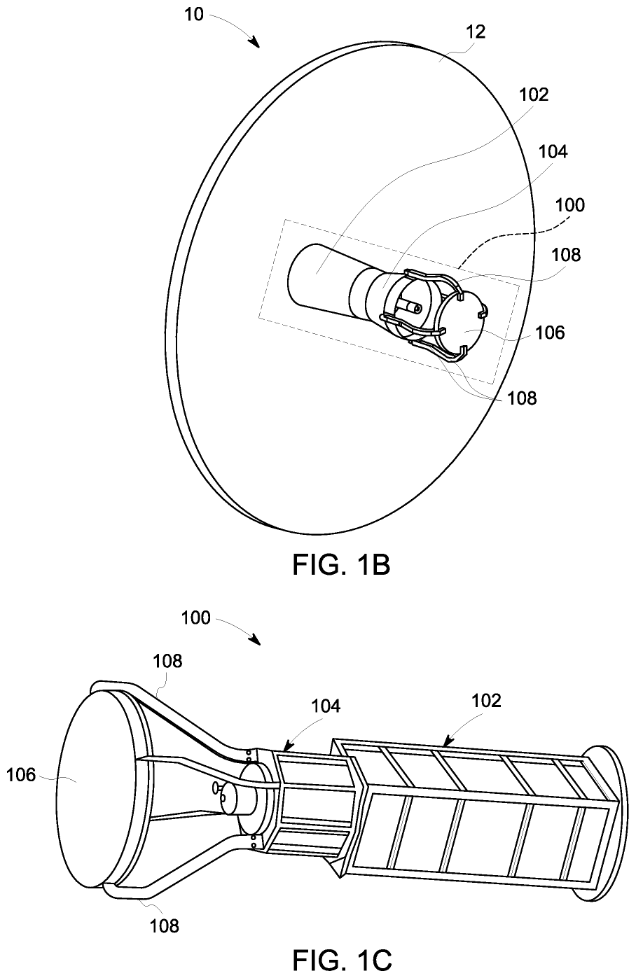

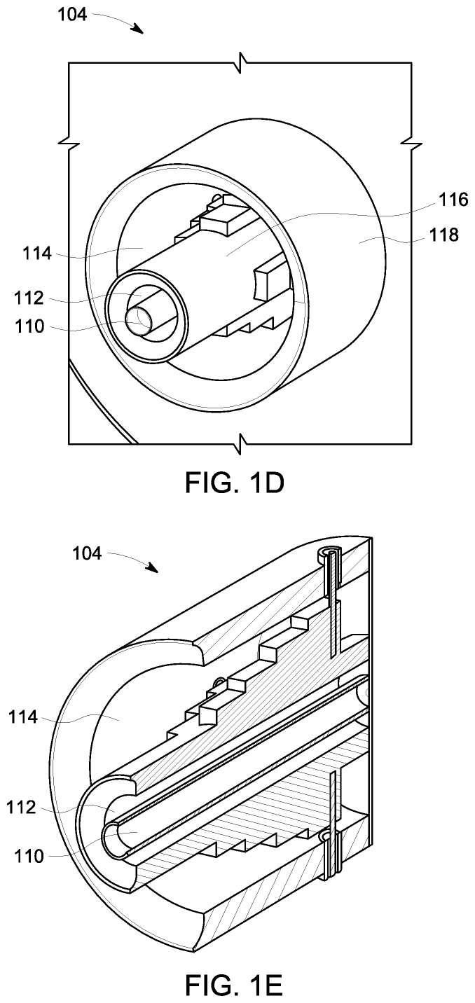

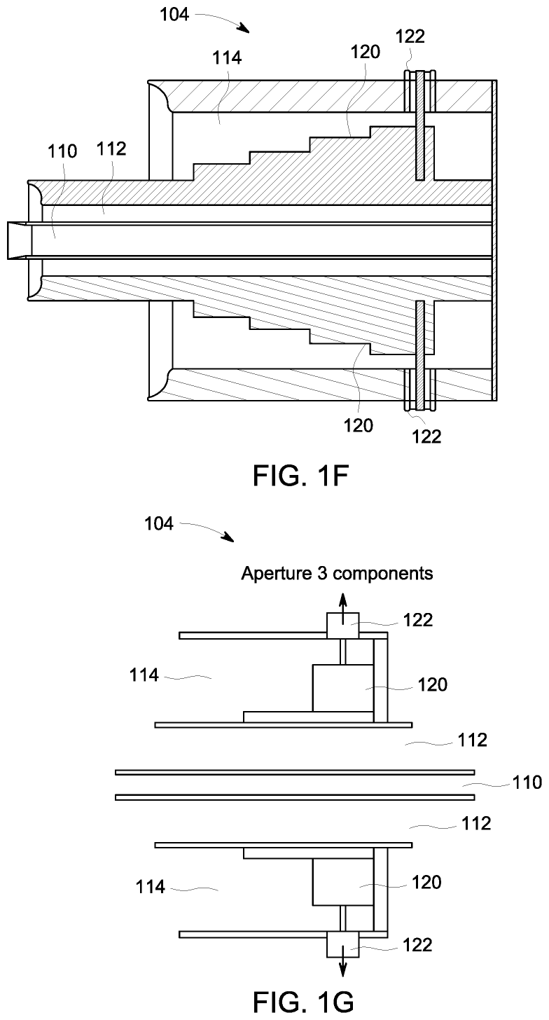

FIG. 1A refers to a perspective view of a conventional ground antenna 18 in according to a prior at embodiment. The conventional ground antenna 18 comprises a main reflector 20, one or more struts 22, a frequency selective sub-reflector 24, and two feeds. The two feeds include a high frequency Ka-band feed 26, and a low frequency S-band or L/S band feed 25. The main reflector 20 is a large-curved dish that has the shape of a parabola. Radio waves entering the main reflector are reflected by the curved surface and directed towards a focal point. The struts are support structures that hold the sub-reflector 24 in place relative to the main reflector 20. The struts are rigid poles or beams that maintain the alignment between the main reflector 20 and the sub-reflector 24 and ensure the conventional ground antenna 18 functions correctly.

The sub-reflector 24 is positioned in front of the main reflector 20 at its focal point. The sub-reflector 24 is configured to receive incoming radio waves that are reflected by the main reflector 20, reflected by the sub-reflector 24, and collimate them towards the feeds (25, 26).

The feeds (25, 26) are located at the focal point of the main reflector 20 that collects or transmits the radio waves. In a receiving antenna, the feeds (25, 26) are configured to collect the radio waves that are reflected by the main reflector 20 and the sub-reflector 24 and converts them into electrical signals. In a transmitting antenna, the feeds (25, 26) receive electrical signals and converts them into radio waves that are then directed by the main reflector 20 and the sub-reflector 24. However, the struts 22 introduces an undesirable side effect. The struts 22 are typically metallic structures positioned across the main reflector 16 of the conventional ground antenna 18. Radio waves, which are essentially electromagnetic waves, travel through the aperture to reach the sub-reflector 24 and the feeds (25, 26). The metallic struts act as obstacles, blocking or attenuating these radio waves as they pass through.

In another mode, the received signals at lower frequency band (S/L) are reflected by the main reflector and collected by the feed 25. In this case, the sub-reflector is transparent to RF signals at low frequency band of S or L.

FIG. 1A depicts the conventional ground antenna 18 with a diameter of 5.4 meters, designed for a relatively narrow beamwidth based on the F/D ratio of 0.37. The sub-reflector diameter of 0.69 meters further contributes to this narrow beamwidth characteristic.

FIG. 1B refers to a perspective view of a multi-band ground antenna 10 with a nested concentric coaxial feed assembly 100 for supporting multiple frequency bands in one embodiment of the present invention. The nested concentric coaxial feed assembly 100 is attached to an antenna reflector 12 through an attachment unit. The nested concentric coaxial feed assembly 100 is located at a reflector focal point of the antenna reflector 12. The attachment unit comprises, but not limited to, nuts, bolts, and an adjustable joint. The nested concentric coaxial feed assembly 100 comprises an elongated housing 102, a feed cone 104, and a sub-reflector 106, as shown FIG. 1C. The nested concentric coaxial feed assembly 100 operates seamlessly across a wider bandwidth, without any gaps or performance drops. In another embodiment, the multi-band ground antenna 10 can be a reflector antenna.

In one embodiment herein, the multi-band ground antenna 10 having a diameter of 5.4 m, an F/D ratio of 0.37, and the sub-reflector diameter of 0.69 m.

In one embodiment, the elongated housing 102 is configured to enclose one or more antenna components. One end of the elongated housing 102 is attached to the antenna reflector 12 at the reflector focal point. The feed cone 104 is attached at one end of the elongated housing 102. The feed cone 104 comprises a first waveguide 110 surrounded by one or more coaxial cylinders (116, 118).

In one embodiment, the first waveguide 110 is also called as an aperture 1. The coaxial cylinders (116, 118) are configured to form one or more coaxial waveguides (112, 114) within the feed cone 104, as shown in FIGS. 1D to 1G. Each coaxial waveguide (112, 114) is formed by an air gap between two adjacent coaxial cylinders. The coaxial waveguides comprise an intermediate waveguide 112 and an outermost waveguide 114. In one embodiment, the intermediate waveguide 112 could be a second waveguide and the outermost waveguide 114 is a third waveguide.

In one embodiment, the intermediate waveguide 112 could also be called as aperture 2, and the outermost waveguide 114 is also called as aperture 3. The coaxial cylinders comprise an inner coaxial cylinder 116, and an outermost coaxial cylinder 118. In one embodiment, the inner coaxial cylinder 116 and the outermost coaxial cylinder 118 are hollow coaxial cylinders. In one embodiment, the inner coaxial cylinder 116 is a first coaxial cylinder, and the outermost coaxial cylinder 118 is a second coaxial cylinder. In specific, the first waveguide 110 is a circular horn open-ended waveguide or a cylindrical core waveguide. The coaxial waveguides (112, 114) are coaxial horn open-ended waveguide.

In another embodiment, the nested concentric coaxial feed assembly 100 includes the cylindrical core waveguide 110, encircled by two hollow coaxial cylinders (116, 118) which respectively forms two coaxial waveguides (112, 114). The outermost waveguide 114 is an outermost waveguide and is bounded between the outermost coaxial cylinder 118 and the inner coaxial cylinder 116. The coaxial waveguide 112 could be an intermediate waveguide that is bounded between the inner coaxial cylinder 116 and cylindrical core waveguide 110.

In one embodiment, the “first waveguide 110” or “cylindrical core waveguide”, or “aperture 1” or “central waveguide” as used interchangeably herein, is intended to mean a path way for signals to travel. The “intermediate waveguide 112” or “second waveguide” or “aperture 2” or “intermediate coaxial cavity” as used interchangeably herein, is intended to mean a path way for signals to travel. The “outermost waveguide 114” or “third waveguide” or “aperture 3” or “outermost coaxial cavity” as used interchangeably herein, is intended to mean a path way for signals to travel.

In some embodiment, the hollow coaxial cylinders (116, 118) are conductive and form a plurality of coaxial waveguides (112, 114), bounded between pairs of consecutive hollow coaxial cylinders. Each coaxial waveguide (112, 114) has an annular cylindrical cavity, with an inner radius and circumference defined by the inner coaxial cylinder 116 and an outer radius and circumference defined by the outermost coaxial cylinder 118. The number of coaxial waveguides defines the number of sub-set of frequency bands supported.

In one embodiment, the nested concentric coaxial feed assembly 100 further comprises at least one impedance matching structure 120 encircling at least one inner coaxial cylinder 116. The impedance matching structure 120 is configured to adjust the impedance of the nested concentric coaxial feed assembly 100. The impedance matching structure 120 have a shape includes at least one of a ramp, steps and a descending curve. The nested concentric coaxial feed assembly 100 further comprising one or more coaxial connectors 122 disposed on at least one coaxial cylinder 118. The coaxial connectors are configured to connect to the antenna components. The inner coaxial cylinder 116 is incorporated with a beam forming network (BFN) for limiting power usage.

In one embodiment, the antenna components include at least one of switches, filters, amplifiers, coaxial cables and other similar components. The sub-reflector supports 108 are extending from the feed cone 104.

In one embodiment, the nested concentric coaxial feed assembly 100 further comprises one or more waveguide ports. The waveguide ports are configured for providing a sum signal or a difference signal, for each frequency band including a C-band, an S-band, a K-band, a Ka-band, a Ku-band, a X-band, and an L-band. The multi-band ground antenna is configured to operate across a wide range of frequencies varies between 2 GHz and 36 GHz. The multi-band ground antenna is configured to operate in multiple frequency bands, including at least one of C, X, Ku, K, and upper Ka bands, or S and Ka-bands.

In one embodiment, the cylindrical core waveguide 110 and the coaxial waveguides (112, 114) are arranged in a nested configuration to minimize feed size and complexity of the multi-band ground antenna 10. The sub-reflector supports 108 that are supporting the sub-reflector 106 are integrated within the feed cone 104, eliminating struts from the antenna reflector 12 to avoid signal blockage, thereby improving overall antenna performance and enhancing signal gain. The sub-reflector 106 features an inner reflecting surface specifically designed and shaped to minimize radio frequency (RF) blockage effects and enhance the gain of the multi-band ground antenna 10.

The switches, filters, and amplifiers integrated within the feed cone 104, minimizing signal loss by avoiding long cables. The coaxial waveguides (112, 114) are designed with impedance matching structure 120 to ensure optimal signal transmission across all supported frequency bands.

In one embodiment, the multi-band ground antenna 10 connects to a plurality of radio frequency (RF) tracking networks. The RF tracking networks operate at one or more frequency bands for providing accurate positioning of the multi-band ground antenna 10 to receive/transmit radio frequency signals.

In another embodiment, design of the nested concentric coaxial feed assembly 100 is scalable to accommodate additional frequency bands by adding further coaxial cylinders and adjusting coaxial waveguide design. The design the nested concentric coaxial feed assembly 100 allows for the reuse of existing main reflector and gimbals, reducing infrastructure costs and simplifying implementation. The sub-reflector 106 is supported by the nested concentric coaxial feed assembly 100, enabling efficient signal transmission and reception across various frequencies. In another embodiment, the shape and design of inner reflecting surface of the sub-reflector 106 is optimized to minimize blockage effects caused by the feed cone 104 and the sub-reflector 106. By avoiding blockage and minimizing feed losses, this nested concentric coaxial feed assembly 100 achieves a significant gain improvement of over 1 dB compared to existing antennas, translating to stronger signal transmission and reception.

In another embodiment, the multi-band ground antenna 10 design utilizing a multiple coaxial cavity ring feed structure offers a compelling solution for overcoming the limitations of traditional antennas. With its expanded frequency range, strut-free design, infrastructure reuse, and improved gain, this technology has the potential to revolutionize communication capabilities in various applications, including deep space exploration and satellite communication.

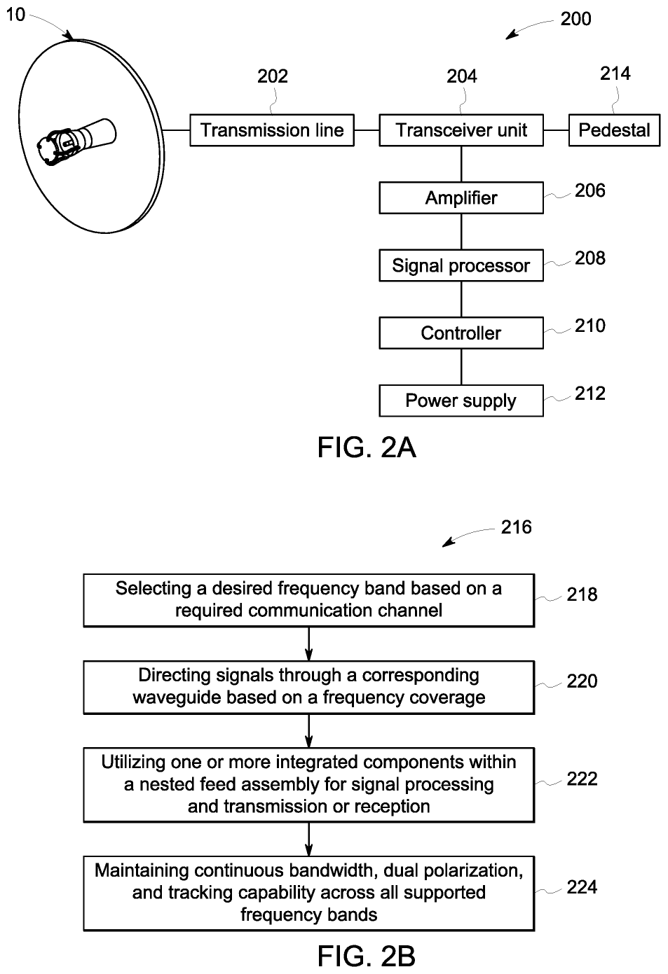

FIG. 2A refers to a block diagram of a ground station system 200. The ground station comprises the multi-band ground antenna 10 attached to various components of the ground station. The multi-band ground antenna 10 is configured for transmitting and receiving radio frequency signals. The nested concentric coaxial feed assembly 100 and the antenna reflector 12 of the multi-band ground antenna 10 are configured to radiate or receive electromagnetic waves efficiently. The multi-band ground antenna 10 is connected to the rest of the ground station system 200 through a transmission line 202. In one embodiment, the transmission line 202 is either a waveguide or cable that carries radio frequency signals between the multi-band ground antenna 10 and other components of the ground station system 200.

The multi-band ground antenna 10 is connected to a transceiver unit 204 for generating outgoing signals for transmission and receiving incoming signals from the multi-band ground antenna 10. The transceiver unit 204 comprises a transmitter and a receiver. The transmitter is configure to modulate the outgoing signals. The receiver is configured to demodulate the incoming signals.

The transceiver unit 204 is connected to one or more amplifiers 206. The amplifiers 206 are configured to boost the strength of signals to compensate for losses in the nested concentric coaxial feed assembly 100 or to enhance the signal before transmission.

A signal processor 208 is connected to the amplifiers 206. The signal processor 208 is configured for processing the incoming signals received by the multi-band ground antenna 10. In another embodiment, the signal processor 208 is configured to perform functions such as filtering, demodulation, decoding, and error correction to extract useful information from the received signals.

A controller 210 is a central unit of the ground station system 200. The controller 210 is configured to control and coordinates the operation of the multi-band ground antenna system 200. Further, the controller 210 is configured to control parameters such as antenna pointing direction, frequency selection, power levels, and data processing.

The ground station system 200 comprises a power supply unit 212 that is configured to provide electrical power. In one embodiment, the power supply unit 212 comprises, but not limited to, batteries, generators, or connections to the electrical grid, depending on the specific requirements of the system.

A pedestal 214 is configure to support the multi-band ground antenna 10 and other electronics. It may allow the antenna to move so it can point in different directions to obtain the desired link with a satellite.

FIG. 2B refers to a flowchart 216 a method for operating the multi-band ground antenna 10 to support multiple frequency bands. The method comprises selecting a desired frequency band based on a required communication channel, as depicted at step 218. The method further comprises directing signals through a corresponding waveguide based on a frequency coverage, as depicted at step 220. The method comprises utilizing one or more integrated components within the nested concentric coaxial feed assembly 100 for signal processing and transmission or reception, as depicted at step 222. The method thereafter comprises maintaining continuous bandwidth, dual polarization, and tracking capability across all supported frequency bands, as depicted at step 224.

In another embodiment, the method proposes a cost-effective solution for expanding the capabilities of existing deep-space network main reflectors. By incorporating the nested concentric coaxial feed assembly 100 and the sub-reflector 106. The combination of the existing deep-space network main reflectors with the nested concentric coaxial feed assembly 100 and the sub-reflector 106 can accommodate several additional frequency bands, enabling communication with a wider range of satellites, planetary bodies, and celestial objects with enhanced capacity and functionality.

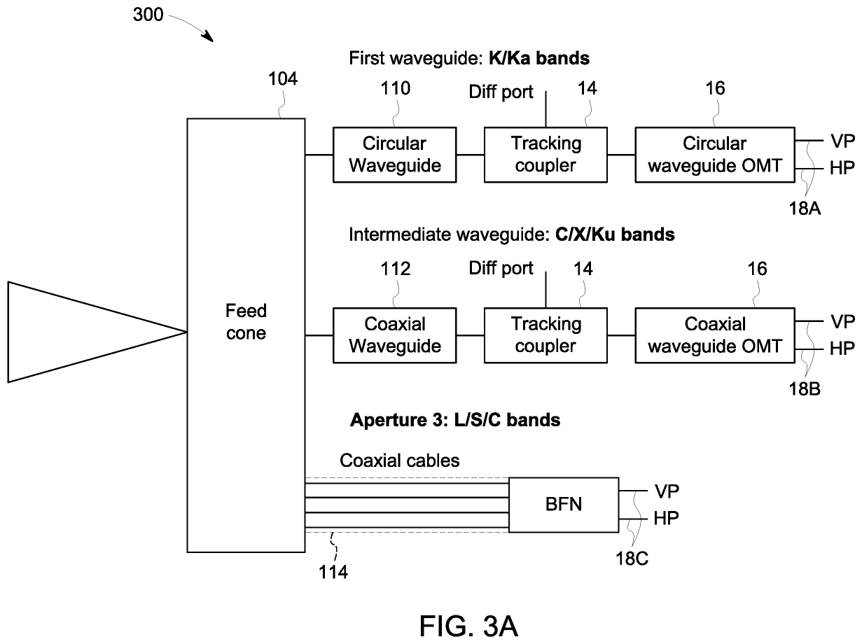

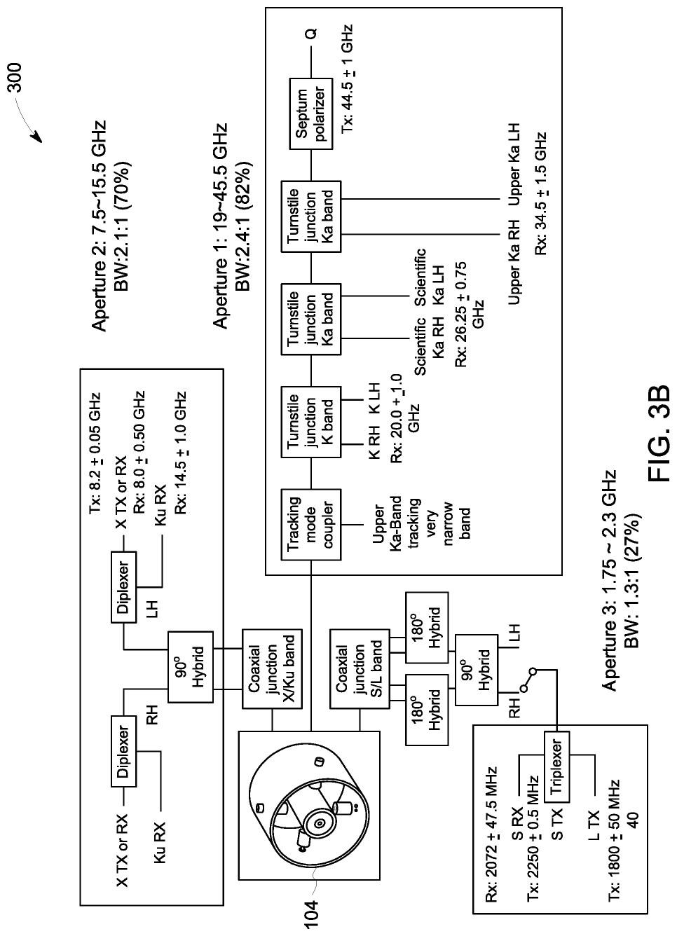

FIGS. 3A-3B refer to a block diagram 300 of the feed cone 104. In another embodiment, thee nested concentric coaxial feed assembly 100 has one or more waveguide ports (18A, 18B, 18C) and is made up of coaxial cylinders (116, 118) around the cylindrical core waveguide 110. This design helps to achieve a wider bandwidth and keeps the phase centers of all coaxial cylinders on the same axis. Each coaxial cylinder can support close to octave bandwidth. The coaxial cylinders are stacked around each other to expand the feed bandwidth while minimizing gaps between individual bandwidths. The inner coaxial cylinder 116 can offset in front of the coaxial cylinders to improve impedance match. Components for the cylindrical core waveguide 110 and the inner coaxial cylinder 116 are based on waveguide technology to reduce loss, but transition to coaxial cables can also be implemented if necessary.

Based on the design, the nested concentric coaxial feed assembly 100 supports dual linearly polarized communication. The waveguide ports (18A, 18B, 18C) are phase matched, so the feed can be converted to circularly polarize by connecting the output ports to 90 degree 3 dB hybrid couplers. Each coaxial cylinder (118, 116) is connected to a tracking coupler 14, which can be TE21 tracker. In FIG. 3A, the cylindrical core waveguide 110 and the inner coaxial cylinder 116 have tracking couplers 14, each providing the port (18A, 18B) to the difference signal. The sum signal is provided by an orthomode transducer 16 (OMTs). To support the required bandwidth and phase, OMTs are symmetric turn-style junctions based on double-rigged waveguide technology.

The outermost waveguide 114 has a direct transition to coaxial transmission lines. A stepping structure 120 in the outermost coaxial cylinder 118 and on the inner coaxial cylinder 116 and cavity behind the coaxial pin transform the outermost coaxial cylinder 118 impedance to 50 Ohm. Four coaxial cables are combined into two ports 18C by 180° hybrids. If low loss and high power capability are needed, the hybrids can be made as power splitters based on an E-plane waveguide tee with double ridges to support bandwidth.

In one embodiment, the aperture 1 comprises the tracking coupler 14 that is configured to track a very narrow band such as upper Ka-band. Further, the aperture 1 comprises one or more turnstile junctions (OMTs) to support the required bandwidth and phase of K-band, and Ka-band. In one embodiment, the aperture 1 has operating frequency range of at least 19 to 45.5 GHz. The aperture 1 has a bandwidth that covers a range of frequencies 2.4 times wider than a center frequency (2.4:1). Therefore, the bandwidth encompasses 82% of the total operating range.

The aperture 2 comprises a coaxial junction to support the required bandwidth of X and Ku bands. The aperture 2 is connected to a 90° hybrid, and a plurality of diplexers. The aperture 2 has operating frequency range of 7.5 to 15.5 GHz. The aperture 2 has a bandwidth that covers a range of frequencies 2.1 times wider than a center frequency (2.1:1). Therefore, the bandwidth encompasses 70% of the total operating range.

The aperture 3 comprises a coaxial junction to support the required bandwidth of S and L bands. The aperture 3 is connected to a 90° hybrid and two 180° hybrids, and at least one triplexer. The aperture 3 has operating frequency range of 1.75 to 2.3 GHZ. The aperture 3 has a bandwidth that covers a range of frequencies 1.3 times wider than a center frequency (1.3:1). Therefore, the bandwidth encompasses 27% of the total operating range.

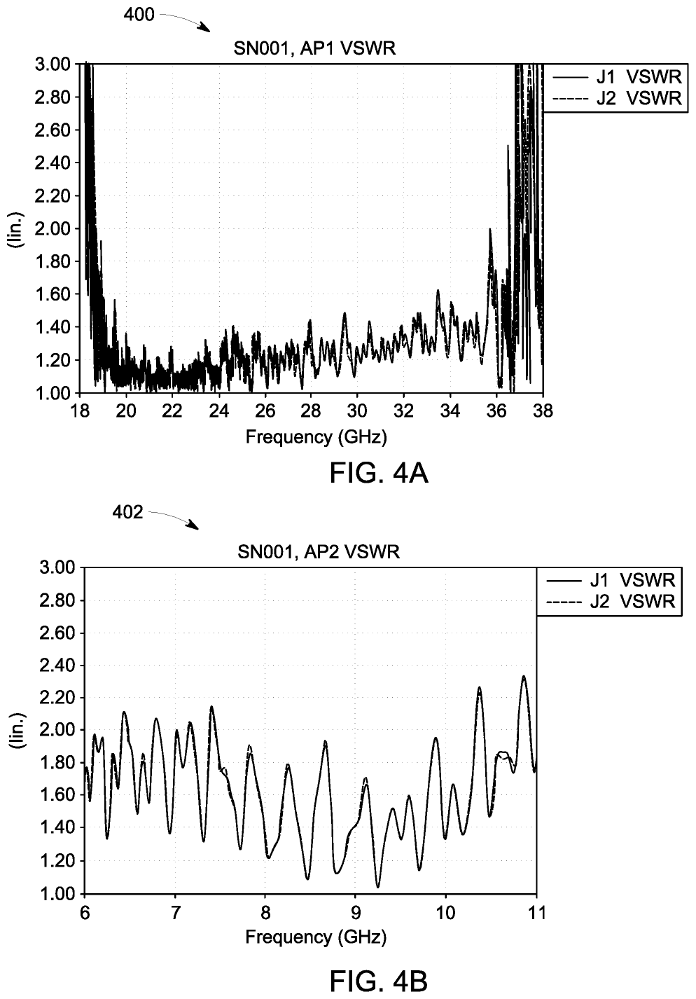

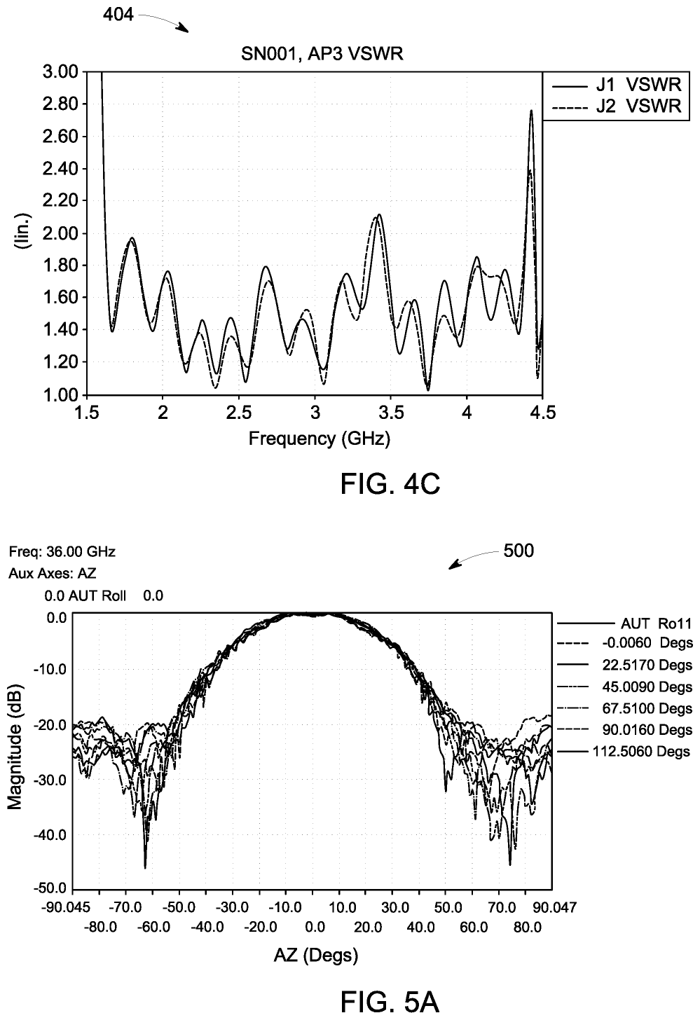

FIG. 4A refers to a graphical plot 400 depicting voltage standing wave ratio (VSWR) of the first waveguide 110 over the 19 GHz to 36 GHz. A VSWR value of lower than 2:1 is met over the entire band. FIG. 4B refers to a graphical plot 402 depicting VSWR of the intermediate coaxial cavity 112 over the desired 7.5 GHZ to 15.5 GHz frequency range. The VSWR is better than 2:1 over the entire band. FIG. 4C refers to a graphical plot 404 depicting VSWR of the outermost coaxial cavity 114 over the 1.75 GHz to 4.0 GHz showing better than 2:1 VSWR over the entire band VSWR measures the ratio between the maximum and minimum voltage of standing waves. A perfect match (no reflection) results in a VSWR of 1:1, meaning the voltage remains constant throughout the line. As the mismatch increases, the reflected wave becomes stronger, leading to higher VSWR values.

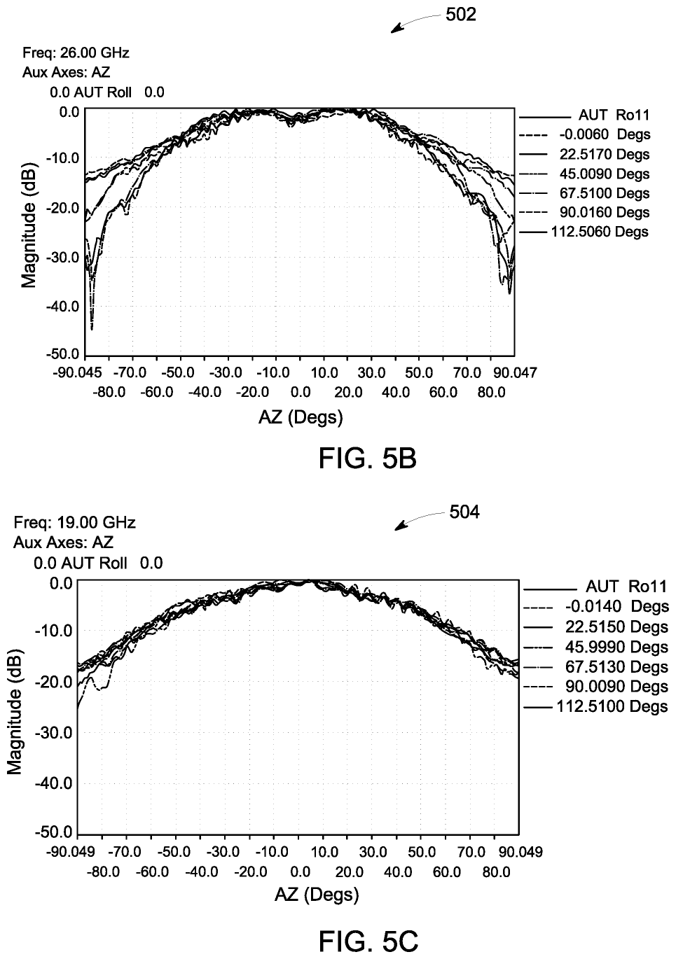

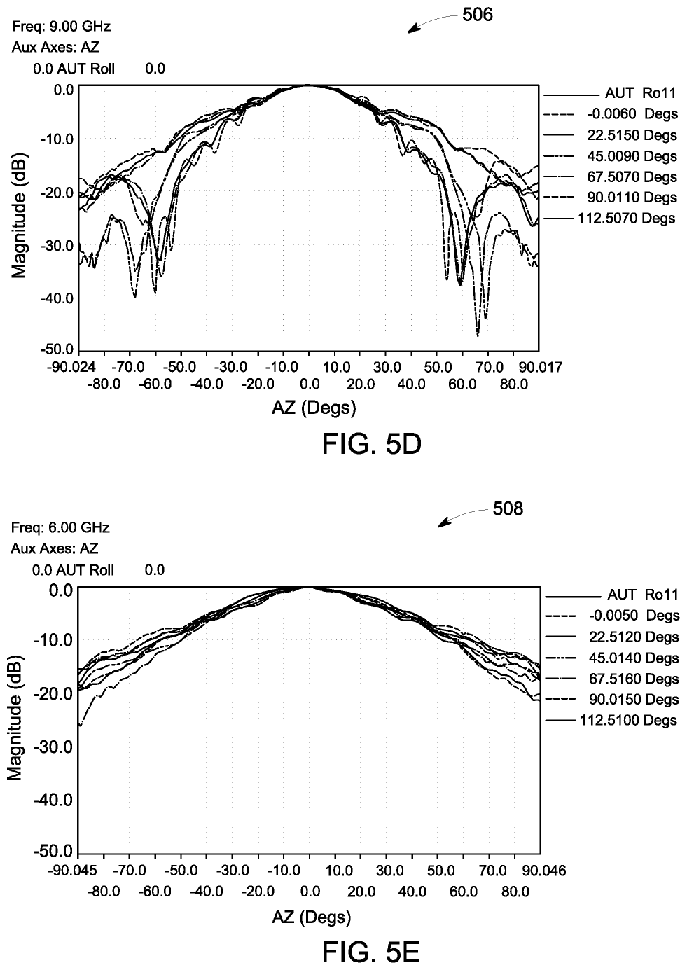

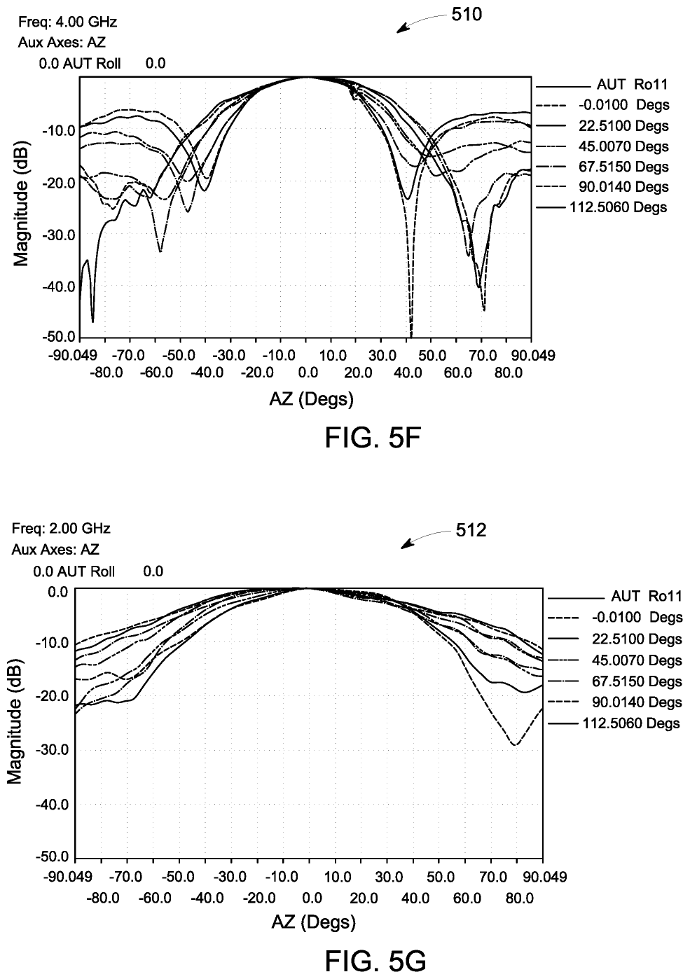

FIGS. 5A-5G refer to radiation patterns of the nested concentric coaxial feed assembly 100 at various operating frequencies. The radiation patterns 500 of the nested concentric coaxial feed assembly 100 at 36 GHz, is depicted in FIG. 5A for the first waveguide 110, radiation pattern is plotted in different azimuthal cuts. The radiation patterns 502 of the nested concentric coaxial feed assembly 100 at 26 GHZ, is depicted in FIG. 5B. The radiation patterns 504 of the nested concentric coaxial feed assembly 100 at 19 GHz, is depicted in FIG. 5C. The radiation patterns 506 of the nested concentric coaxial feed assembly 100 at 9 GHz, is depicted in FIG. 5D. The radiation patterns 508 of the nested concentric coaxial feed assembly 100 at 6 GHz, is depicted in FIG. 5E. The radiation patterns 510 of the nested concentric coaxial feed assembly 100 at 4 GHz, is depicted in FIG. 5F for the outermost coaxial cavity 114. The radiation patterns 512 of the nested concentric coaxial feed assembly 100 at 2 GHz, is depicted in FIG. 5G for the outermost coaxial cavity 114.

In one embodiment, the nested concentric coaxial feed assembly 100 operates seamlessly across a wider bandwidth, without any gaps or performance drops. The multi-band ground antenna with multiple bands is being introduced for ground communications. The multi-band ground antenna comprises a nested concentric coaxial feed assembly, which supports frequencies varies between 2 GHz and 36 GHz. The multi-band ground antenna is designed to be used in satellites and aircraft.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A nested concentric coaxial feed assembly of a multi-band ground antenna for supporting multiple frequency bands, comprising:
an elongated housing configured to enclose one or more antenna components;
a feed cone attached at one end of said elongated housing, wherein said feed cone comprises:
a first waveguide; and
one or more coaxial cylinders, wherein said one or more coaxial cylinders are configured to encircle said first waveguide, thereby forming one or more coaxial waveguides, which are bounded between pairs of consecutive coaxial cylinders;
a sub-reflector located at a distal end of said feed cone having an outer rim supported by one or more sub-reflector supports; and
a plurality of radio frequency (RF) tracking networks configured to operate at one or more frequency bands for providing accurate positioning of the multi-band ground antenna to receive radio frequency signals,
whereby, said nested concentric coaxial feed assembly operates seamlessly across a wider bandwidth without any gaps or performance drops.

2. The nested concentric coaxial feed assembly of claim 1, wherein said multi-band ground antenna further comprises:
an antenna reflector, wherein said nested concentric coaxial feed assembly is installed at a reflector focal point of said antenna reflector.

3. The nested concentric coaxial feed assembly of claim 1, wherein said nested concentric coaxial feed assembly further comprises at least one impedance matching structure encircling at least one of said coaxial cylinder, wherein said at least one impedance matching structure is configured to adjust the impedance of the nested concentric coaxial feed assembly.

4. The nested concentric coaxial feed assembly of claim 3, wherein said at least one impedance matching structure having a shape includes at least one of a ramp, steps and a descending curve.

5. The nested concentric coaxial feed assembly of claim 1, wherein said nested concentric coaxial feed assembly further comprises one or more coaxial connectors disposed on at least one of said coaxial cylinder.

6. The nested concentric coaxial feed assembly of claim 5, wherein said one or more coaxial connectors are configured to connect to said one or more antenna components.

7. The nested concentric coaxial feed assembly of claim 1, wherein said nested concentric coaxial feed assembly further comprises one or more waveguide ports, wherein said one or more waveguide ports are configured for providing a sum signal or a difference signal for each frequency band including a C-band, an S-band, a K-band, a Ka-band, a Ku-band, a X-band, and an L-band.

8. The nested concentric coaxial feed assembly of claim 1, wherein said one or more coaxial waveguides comprise at least one of an intermediate waveguide and an outermost waveguide.

9. The nested concentric coaxial feed assembly of claim 1, wherein said first waveguide is at least one of a circular horn open-ended waveguide and a cylindrical core waveguide.

10. The nested concentric coaxial feed assembly of claim 1, wherein said one or more coaxial waveguides are coaxial horn open-ended waveguide.

11. The nested concentric coaxial feed assembly of claim 1, wherein at least one coaxial waveguide is incorporated with a beam forming network (BFN) for limiting power usage.

12. The nested concentric coaxial feed assembly of claim 1, wherein said multi-band ground antenna is configured to operate across a wide range of frequencies varies between 2 GHz and 36 GHz.

13. The nested concentric coaxial feed assembly of claim 1, wherein said multi-band ground antenna is configured to operate in multiple frequency bands include at least one of C, X, Ku, K, upper Ka bands, S and Ka-bands.

14. The nested concentric coaxial feed assembly of claim 1, wherein said one or more antenna components include at least one of switches, filters, amplifiers, coaxial cables and other components.

15. The nested concentric coaxial feed assembly of claim 1, wherein said one or more sub-reflector supports are extending from the feed cone.

16. A nested concentric coaxial feed assembly of a multi-band ground antenna for supporting multiple frequency bands, comprising
an elongated housing configured to enclose one or more antenna components;
a feed cone attached at one end of said elongated housing, wherein the feed cone comprises:
a circular horn open-ended waveguide located on a central axis of said feed cone;
a first coaxial cylinder encircling said circular horn open-ended waveguide, thereby forming an intermediate waveguide, which is bounded between said first coaxial cylinder and said circular horn open ended waveguide; and
a second coaxial cylinder encircling said first coaxial cylinder, thereby forming an outermost waveguide, which is bounded between said second coaxial cylinder and said first coaxial cylinder; and
a sub-reflector located at a distal end of said feed cone having an outer rim supported by one or more sub-reflector supports, wherein the sub-reflector having an inner reflecting surface that is shaped to minimize RF blockage effects and improve gain of the multi-band ground antenna.

17. The nested concentric coaxial feed assembly of claim 16, wherein said nested concentric coaxial feed assembly further comprises at least one impedance matching structure encircling at least one coaxial cylinder, wherein said at least one impedance matching structure is configured to adjust the impedance of the nested concentric coaxial feed assembly.

18. The nested concentric coaxial feed assembly of claim 17, wherein said at least one impedance matching structure having a shape includes at least one of a ramp, steps and a descending curve.

19. The nested concentric coaxial feed assembly of claim 16, wherein said nested concentric coaxial feed assembly further comprises one or more coaxial connectors disposed on at least one coaxial cylinder.

20. A method for operating a multi-band ground antenna to support multiple frequency bands using a nested concentric coaxial feed assembly, comprising:
selecting a desired frequency band based on a required communication channel;
directing signals through a corresponding waveguide based on a frequency coverage;
utilizing one or more integrated components within a feed cone for signal processing and transmission or reception; and
maintaining continuous bandwidth, dual polarization, and tracking capability across all supported frequency bands.
